(19) United States
(12) Patent Application Publication
(10) Pub. No.: US 2006/0075677 A1
(43) Pub. Date: Apr. 13, 2006

(54) Fishing rod and tackle carrier

(76) Inventor: Robert Kuiack, Ottawa (CA)

Correspondence Address: KELLEY DRYE & WARREN LLP, TWO STAMFORD PLAZA, 281 TRESSER BOULEVARD, STAMFORD, CT, 06901, US

(21) Appl. No.: 11/243,065

(22) Filed: Oct. 4, 2005

Related U.S. Application Data
(60) Provisional application No. 60/616,213, filed on Oct. 7, 2004.

(51) Int. Cl. A01K 97/08; A01K 97/06

(52) U.S. Cl. 43/26; 43/54.1

(57) ABSTRACT

A fishing rod and tackle carrier is disclosed. The container encloses a portion of a fishing pole. The fishing pole has a reel and a rod. The container includes two substantially rigid and opposing end walls. The end walls are spaced apart a distance large enough to suspend the pole and permit the reel to fit inside the container. The upper rims of the end walls define opposing recesses which are shaped to receive one or more rods with such rods being held securely in place when the lid of the container is closed.

### RELATED APPLICATION

This application claims the benefit under Title 35, U.S.C., S.119(e) of United States provisional application 60/616,213 filed Oct. 7, 2004.

### FIELD OF THE INVENTION

The present invention relates to sport fishing gear, in particular a carrier for fishing rods and tackle.

### BACKGROUND OF THE INVENTION

The sport of fishing often requires the fisherman to carry a substantial amount of equipment to the fishing site. This equipment can include rods, reels, bait, artificial lures, knives, weights, floats and other tackle. This equipment can be damaged or lost if it is not properly stored and protected. For example, an unprotected pole can be dropped or the rod or reel can be damaged when the fisherman is moving through rough terrain from one fishing location to another. Sand becoming lodged in the reel as a result of the reel being dropped or dragged can be particularly damaging.

There are some known devices which can be categorized as fishing pole carriers. U.S. Pat. No. 5,414,953 of Taylor issued May 16, 1995 discloses an open-faced tackle box. The tackle box has vertical end panels each having a slot to receive a fishing pole. The rod is suspended between the slots. The tackle box thus holds one or two fishing poles for convenient carrying.

U.S. Pat. No. 6,085,455 of Bracken et al. issued Jul. 11, 2000 discloses a protective container for a fishing pole. The container has openings in the end walls to permit both ends of a fishing pole to protrude from the container. A compartment within the container permits storage of a plurality of fishing hooks. The patent does not disclose means to protect the reel of a fishing pole.

It is an object of the present invention to provide an improved fishing rod and tackle carrier, preferably for carrying one or more telescoping rod and reel sets and miscellaneous tackle.

### SUMMARY OF THE INVENTION

According to one aspect of the invention, there is provided a container for a portion of a fishing pole and associated tackle. The fishing pole comprises a reel and a rod. The container includes two substantially rigid and opposing end walls. The rigid end walls are spaced apart a distance large enough to permit the reel to fit within the interior of the container between the walls. At least one and preferably both of the rigid walls include a recess opening upwardly to receive and cradle a rod. Two foldable and opposing walls permit the container to be collapsed when not in use. A fastener is adapted to fasten a fishing pole to the container.

In one embodiment, the fastener includes a lid and a cover extendable across the lid. The cover is attached to a selected one of: one of the rigid walls, one of the foldable walls, and the cover is also releasably attached to a selected one of: the other of the rigid walls, the other of the foldable walls.

In an alternative version, rigid side and end walls are provided. An upper rim cap comprising rigid molded plastic cover, shaped like an inverted trough, is fitted onto the upper edge of the side and end walls to form a durable upper rim for the carrier. Either of the side walls or end walls, or both, may comprise a rigid or semi-rigid closed-cell foam to provide flotation. Additional flotation may be provided within the cover, this flotation preferably comprising foam closed-cell foam retained within a fully enclosed pocket within the cover. The foam within the cover also provides additional protection for the rod and reel and other contents of the container.

In one embodiment, the container is sized to house a plurality of rod and reel sets.

The fishing rod carrier according to the present invention protects fishing rods and reels from damage, while providing a secure means to carry the rods and reels (one or more thereof) as well as associated tackle.

An advantage of the fishing rod carrier according to the present invention is that it has storage compartments like pockets or storing fishing tackle and other small items.

Another advantage of the fishing rod carrier according to one aspect of the present invention is that it is collapsible to permit better storage of the carrier when it is not in use.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the present patent specification as a whole. In particular, but without limiting the generality of the foregoing, it will be understood that all dimensions and sizes described herein, both relative and absolute, may be varied within a broad range to provide a carrier sized to the desired use. As well, materials described herein are merely intended to be illustrative and are subject to a range of alternatives. Directional references herein such as “upper”, “lower”, “horizontal”, etc. are merely intended for convenience of description. As well, “fabric” includes vinyl or other flexible sheeting material; “foam” includes any type of rigid or semi-rigid buoyant material.

### BRIEF DESCRIPTION OF THE DRAWINGS

These and other advantages of the invention will become apparent upon reading the following detailed description and upon referring to the drawings in which:

FIG. 1 is a perspective view of an embodiment of a fishing pole carrier, according to the present invention, with a top cover removed from the carrier;

FIG. 2 is an end view of the fishing pole carrier;

FIG. 3 is a top view of the fishing pole carrier, with the top cover removed and a fishing pole within the carrier; and

FIG. 4 is a side elevational view of two of the fishing pole carriers attached together, one on top of the other.

### DETAILED DESCRIPTION OF THE PREFERRED EMBODIMENTS

In the following description, similar features in the drawings have been given identical reference numerals where appropriate. All dimensions described herein are intended solely to illustrate an embodiment. These dimensions are not intended to limit the scope of the invention that may depart from these dimensions.

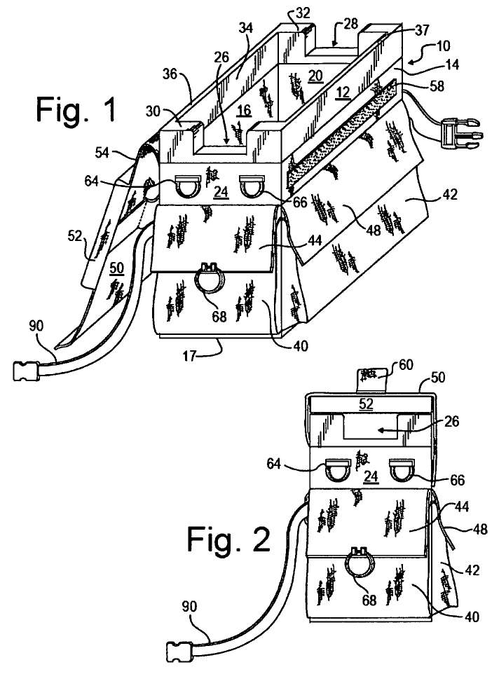

Turning to FIG. 1, there is illustrated a carrier 10 for carrying a fishing pole and tackle. In the illustrated embodiment, the carrier 10 is substantially rectangular in shape with an open top. It will be understood however that a variety of different shapes are possible. The carrier comprises a frame composed of rigid or semi-rigid panels, described below, covered by fabric such as waterproof Nylon™. Front and rear side walls 12 and 16 of the container 10 are perpendicular to end walls 20 and 24. The carrier includes a floor 17 which is rigid, semi-rigid or flexible. The side walls may comprise panels fastened to the end walls along the respective lateral edges of the walls by suitable means, for example gluing or stitching. Alternatively, the carrier comprises an exterior fabric shell 14, which may include internal pockets which retain rigid or semi-rigid panels in position to form the respective walls. Alternatively, the fabric cover simply slides over the panels and is held in place by other means. The floor 17 preferably comprises an integral part of the fabric cover 14. An optional foam block 51 rests on the floor 17 and may be glued or otherwise fastened to the cover.

The end panels or walls 20 and 24 are made of a substantially semi-rigid and preferably buoyant material such as closed cell polymeric foam. The end walls 20 and 24 can be each made of a 5 inch by 9 inch by ¾inch block of closed-cell semi-rigid polymeric foam. Alternatively, especially if supplemental flotation members are provided, the end panels may comprise non-buoyant or less-buoyant material, such as rigid or semi-rigid plastic or metal panels, for increased support and strength. For example, the end walls may comprise closed-cell foam or corrugated plastic. The upper portions of side and end walls 12, 16, 20 and 24 define an upper rim which is capped with a rigid plastic rim cap 34. The rim 34 includes opposed depressions or recesses 26 and 28 set into the end walls 20 and 24. The recesses 26 and 28 are aligned with each other to receive a rod and reel. With the cover of the carrier open, a rod and reel may be simply rested on the upper rim, with the rod resting within the opposed depressions 26 and 28. The depressions restrict movement of the rod and reel relative to the carrier. The depressions are relatively broad so as to accommodate two and possibly more rod and reels positioned side by side. The depressions 26 and 28 are also reasonably shallow, such that a typical rod when resting within the depressions is either substantially flush with the rest of the rim or more preferably protrudes slightly above, thus permitting the carrier lid to contact the rod so as to prevent unwanted movement when closed. For example, the handle portion of the rod may protrude upwardly above the rim.

In one embodiment of the fishing pole carrier, the walls 12 and 16 are each made of a 9 inch by 10½inch flexible plastic sheet. These flexible walls permit some bulging for oversized cargo. They also permit the carrier 10 to be collapsed for better storage. In addition, plastic is a suitable material for making a water-resistant container. Alternatively, the side walls 12, 16 may comprise a single sheet of semi-rigid material which curves to form a channel-shaped member which comprises the opposed side walls as well as a floor. Closed cell polymeric foam is a suitable material for making a container that is water-resistant and can float on water. The side walls may also comprise closed-cell foam or corrugated plastic panels. It will be understood however that the type of material used to construct the walls of the container is not in any way essential to the invention. Also the characteristics of the container's walls are not essential to the invention.

The fabric covering 14 comprises a waterproof abrasion and tear-resistant material such as heavy Nylon™ or Corduroy™. The covering 14 also includes various pockets and other attachments as described below. The covering 14 may comprise two layers which retain foam panels therebetween to form at least some of the walls and floor of the carrier. The cover 14 preferably includes a drain hole (not shown) extending through the floor 17.

The upper rim of the carrier 10 preferably comprises a slip-on rigid molded plastic rim cap 34, which is shaped like an inverted trough. The rim cap 34 slips over the uppermost rim of the carrier and is glued into place with a suitable waterproof glue. The rim cap 34 defines the shape of the upper rim, including depressions or openings 26 and 28, which are formed integrally with the rim cap. The cap 34 also provides structural support for the carrier and serves as a substrate to retain the outer covering 14, which is glued to the cap 34.

The carrier 10 also includes optional exterior pockets 40 and 42. The pocket 40 can accommodate small items of tackle such as hooks, spare fishing line, sinkers, lures and worms. It will be seen that any convenient number of pockets 40 and 42 may be provided, with a range of suitable sizes. The pocket 42 can accommodate larger items such as a cell phone, pliers, a small first aid kit and tools. In one embodiment, a second smaller or a series of smaller pockets are attached on the outside of the pocket 42. The pockets 40 and 42 have flaps 44 and 48 respectively which can close the pocket openings. Velcro™ or other attachment means can be used for holding the flaps 44 and 48 in place. The carrier 10 could also have a special sleeve for carrying a water bottle.

Referring to FIGS. 1 and 2, a cover 50 covers the top of the carrier 10. The lid 50 comprises a flap of the fabric cover 14 which when closed covers the carrier and extends partway down the front wall 12. A semi-rigid closed cell foam panel 52, having a degree of resiliency, is fastened to the inside surface of the flap 50 for additional flotation and to contact and snugly grip the poles when closed. The resiliency of the panel 52 enhances the frictional contact between the panel 52 and the poles held within the case by permitting the panel 52 to press downwardly on the poles to retain them within the depressions 26. A Velcro™ connector 58 secures the flap 50 to the front panel 12.

A handle 60 on the cover 50 permits carrying of the carrier 10 when the cover 50 is fastened over the top of the carrier 10. The handle 60 can be made from a 5½% inch by 1¾inch piece of suitable material. It will be understood however that a variety of alternative handles are possible.

Optional loops 64 and 66 are attached to the wall 24. Loop 68 is attached to the flap 44. These loops permit attachment of fishing accessories such as a fish chain. The carrier 10 can also have one or more loops or hooks for hanging the carrier up for storage. The loops of hooks of the carrier 10 can be made of any suitable material such as metal or plastic.

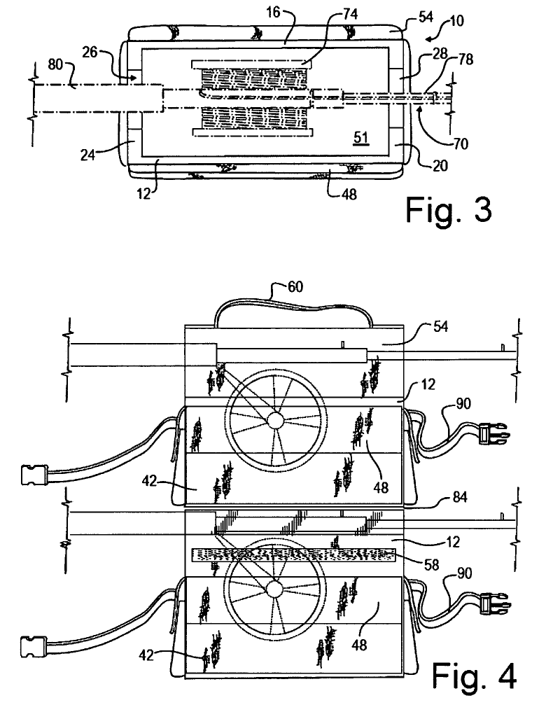

Placement of the fishing pole 70 in the carrier 10 is illustrated in FIG. 3. The fishing pole 70 includes a reel 74, a rod 78, and a handle 80. The fishing rod 78 rests on the two cutouts 26, 28 such that the handle 80 protrudes rearwardly and a portion of the rod 78 protrudes forwardly with the reel 74 being cradled between the cutouts and thus protected from the elements within the interior of the carrier 10.

The reel 74, which in the illustrated embodiment is below the fishing rod 78, fits within the interior space of the carrier 10, defined by the walls 12, 16, 20 and 24. The cutouts are sufficiently deep to permit a conventional rod to fit substantially within the cutouts, such that when the cover is closed the rod is held firmly and without slippage.

The carrier 10 is sized to fit a generally conventional reel attached to a conventional pole. For different applications, the carrier may be sized accordingly. For example, for carrying larger rods and reels, the size may be increased. In an alternative embodiment, the carrier has wider end walls and recesses permitting it to accommodate a plurality of rods. Rods may be secured by use of Velcro™ straps to keep the poles attached to each other and/or to the carrier. The rods may conveniently be retained in opposing directions to position the respective reels in an offset relationship for more compact storage. This positioning is convenient if the rods are highly collapsible.

The fishing pole 70 is preferably fastened to the carrier 10 by a suitable fastener. In the illustrated embodiment, the fastener comprises a top or lid 50 and the cover 54 (see FIG. 2). The cover 50 may permit some side-to-side movement of the fishing rod 78 within the openings 26 and 28; up and down swinging of the rod however is substantially prevented by the illustrated fastener means. Side-to-side movement may be substantially minimized by cinching down the cover 50.

As illustrated in FIG. 4, two of the carriers 10 can be attached one on top of the other by attachment means 84, which in the illustrated embodiment comprises two zippers which extend along the edges of the walls 12 and the walls 16 (walls 16 not shown in FIG. 4). It will be appreciated that the carriers 10 could be attached to each other by other means (for example by clips or hook and loop fasteners).

An optional adjustable waist belt 90 can be used to attach the carrier 10 to the waist of a user. In this manner, both of the hands of the user are free. The belt 90 is therefore particularly useful when the user desires to have the carrier 10 at his side while fishing with his boots in the water. Other means for easing toting of the carrier 10 are possible (e.g. a shoulder strap).

The carrier 10 can assist a fisherman in protecting his reel from damage when he wishes to change his hook, bait, or other item attachable to the end of the fishing pole line. Instead of dropping the fishing pole to the ground while he works with items on the end of the line, the fisherman can keep the fishing pole in the carrier 10.

Thus, it is apparent that there has been provided in accordance with the invention a fishing rod and tackle carrier that fully satisfies the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the broad scope of the invention.

1. A carrier for a fishing pole comprising a rod and reel, said carrier comprising opposed end and side walls and a floor defining an interior space, an open top, an exposed upper rim, an openable lid for covering said open top, and a pair of opposed aligned recesses at said rim within said end walls to receive one or more rod and reels to be retained within said recesses in co-operation with said lid when closed, said reel being cradled between said depressions within said interior space and said end walls or side walls or both being at least partly rigid.

2. A carrier as defined in claim 1 for carrying a plurality of fishing poles in side-by-side relationship.

3. A carrier as defined in claim 1 further comprising a rigid rim cap covering said upper rim, and a fabric cover covering said walls and floor, said fabric cover being fastened to said rim cap.

4. A carrier as defined in claim 1, wherein at least one of said side and end walls comprises a flotation member.

5. A carrier as defined in claim 1, wherein said recesses are broad relative to their height and each have a substantially flat bottom.

6. A carrier as defined in claim 1, wherein said lid comprises an at least partially rigid panel, for contacting said rod and reel when closed and minimizing slippage of said rod and reel relative to said carrier.

7. A carrier as defined in claim 6 wherein said panel is resilient.

8. A carrier as defined in claim 1, wherein said recesses have a depth that is sufficiently shallow to permit a conventional rod and reel to protrude upwardly above said upper rim, such that said lid contacts said rod and reel when closed to minimize slippage.

9. A method of carrying at least one fishing rod and reel unit, comprising the steps of:
providing a carrier comprising opposed end and side walls and a floor defining an interior space, an open top, an exposed upper rim, an openable lid for covering said open top, and a pair of opposed aligned recesses at said rim within said end walls;
placing said at least one rod and reel set within said carrier, such that said reel is cradled between said recesses within the interior of said carrier, and said rod protrudes outwardly from said carrier from either end thereof; and
closing said lid to at least partly retain said rod and reel set within said carrier.

10. A method as defined in claim 9 for carrying a plurality of rod and reel sets in side-by-side relation within said carrier, by placing said rod and reel set substantially side-by-side within said recesses.

11. A method as defined in claim 9, wherein said rod and reel sets are further prevented from slippage by providing as said cover an at least partially rigid and resilient panel for firmly gripping said rod and reel when resting within said recesses, wherein said recesses each have a depth that permits a conventional rod and reel to contact said lid.
